(19) United States
(12) Patent Application Publication
(10) Pub. No.: US 2012/0061890 A1
(43) Pub. Date: Mar. 15, 2012

(54) HYDRAULIC BODY MOUNT

(76) Inventor: Robert J. Goudie, Grand Haven, MI (US)

(21) Appl. No.: 13/169,792

(22) Filed: Jun. 27, 2011

Related U.S. Application Data
(63) Continuation-in-part of application No. 12/928,679, filed on Dec. 16, 2010.
(60) Provisional application No. 61/286,966, filed on Dec. 16, 2009.
(60) Provisional application No. 61/296,382, filed on Jan. 19, 2010.
(60) Provisional application No. 61/358,542, filed on Jun. 25, 2010.

(51) Int. Cl. F16F 15/023

(52) U.S. Cl. 267/140.11

(57) ABSTRACT

Embodiments of hydraulic mounts for vehicles are provided herein. According to some embodiments, hydraulic mounts may include an inner tubular sleeve having a top washer extending circumferentially from a terminal end of the inner tubular sleeve, the inner tubular sleeve extending along a central axis, a tubular spring support surrounding at least a portion of the inner tubular sleeve and forming an annular cavity therebetween, a bottom cup, a first inner spring, a second inner spring, a channel support, a first outer spring, and a second outer spring.

### CROSS-REFERENCE TO RELATED APPLICATION(S)

This application claims the benefit of U.S. Provisional Application Ser. No. 61/358,542, filed Jun. 25, 2010, entitled “Hydraulic Body Mount, Sub-Frame Mount and/or Engine Mount With Elastomeric Spring Assisted Damping,” and this application is a continuation-in-part of U.S. patent application Ser. No. 12/928,679, filed Dec. 16, 2010, entitled “Hydraulic Body Mount,” which claims the benefit of U.S. Provisional Application Ser. No. 61/286,966, filed Dec. 16, 2009, entitled “Short Hydraulic Body Mount With Very High Damping Using Rolling Diaphragm” and U.S. Provisional Application Ser. No. 61/296,382, filed Jan. 19, 2010, entitled “Short Hydraulic Body Mount With Very High Damping Using Rolling Diaphragm,” which are hereby incorporated herein by reference in their entirety, including all references cited therein.

### BACKGROUND OF THE INVENTION

1. Field of the Invention

The present invention relates in general to mounts and more particularly, but not by way of limitation, to hydraulic mounts having a small size and very high vertical damping, and in some embodiments to hydraulic mounts that utilize a displaceable diaphragm.

2. Background Art

Body mounts have been known in the art for years and are the subject of a plurality of applications and patents including, namely: U.S. Pat. No. 7,584,944 entitled “Hydraulically Damped Body Mount With Bolt-Through Construction;” and U.S. Pat. No. 7,637,486 entitled “Very High Damping Body Mount, Subframe Mount Or Engine Mount With Bolt-Through Construction”—all of which are hereby incorporated herein by reference in their entirety including all references cited therein.

In particular, U.S. Pat. No. 7,584,944 (hereinafter sometimes the '944 patent) appears to generally provide a low cost design that affords generally insufficient damping for most applications.

U.S. Pat. No. 7,637,486 (hereinafter sometimes the '486 patent) appears to afford very high damping, but the embodiments also appear to be constrained by the configuration of the packages on associated vehicles.

While the above-identified references appear to disclose a plurality of body mounts, their configurations take up considerable space between the body and the frame. By way of example, embodiments of the '944 patent are between 37 mm and 50 mm high. Embodiments associated with the '939 application are typically 56 mm high. Both of the above designs have approximately 12 mm of travel to function properly.

In comparison, embodiments disclosed in the present invention, are capable of being reduced down to a free height of 26 mm while still having 12 mm of available displacement. So at loaded height, the gap between the body and the frame is only nominal 22 mm. With the same available displacement as the above mounts and also the capability to produce high vertical damping, mounts constructed in accordance with the present invention open up more opportunities to apply this technology. SAE Paper 2009-01-2126 by Ping Lee describes one specific application of these high vertical damped mounts where a considerable improvement in the quality of performance is achieved.

These and other objects of the present invention will become apparent in light of the present specification, claims, and drawings.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be understood that the invention is not necessarily limited to the particular embodiments illustrated herein.

FIG. 1A of the drawings is a perspective view of a hydraulic mount constructed in accordance with the present invention;

FIG. 1B of the drawings is a cross-sectional view of the hydraulic mount of FIG. 1A taken along line A-A;

FIG. 1C of the drawings is a partial cross-sectional view showing a diaphragm of the hydraulic mount of FIGS. 1A and 1B;

FIG. 2 of the drawings is a cross-sectional view of an alternative hydraulic mount;

FIG. 3A of the drawings is a cross-sectional view of yet another hydraulic mount;

FIG. 3B of the drawings is a perspective view of one half of a tubular body for use with the hydraulic mount of FIG. 3A;

FIG. 3C of the drawings is a perspective view of an alternate tubular body for use with the hydraulic mount of FIG. 3A;

FIG. 4 of the drawings is a cross-sectional view of yet another hydraulic mount having a tubular pathway;

FIG. 5 of the drawings is a cross-sectional view of an additional hydraulic mount, constructed in accordance with the present technology;

FIG. 6A of the drawings is a cross-sectional view of another embodiment of a hydraulic mount;

FIG. 6B of the drawings is an exploded, partial, cross-sectional view of the hydraulic mount of FIG. 6A;

FIG. 6C of the drawings is a cross-sectional view of the hydraulic mount of FIG. 6A, shown in an installed configuration;

FIG. 7 of the drawings is a cross-sectional view of a double hydraulic mount; and

FIG. 8 of the drawings is a cross-sectional view of an alternative double hydraulic mount.

### SUMMARY OF THE INVENTION

According to some embodiments, the present technology may be directed to a hydraulic mount that comprises: (a) an inner tubular sleeve having a top washer extending circumferentially from a terminal end of the inner tubular sleeve, the inner tubular sleeve extending along a central axis; (b) a tubular spring support surrounding at least a portion of the inner tubular sleeve and forming an annular cavity therebetween; (c) a bottom cup disposed below the top washer; (d) a first inner spring extending circumferentially from the top washer to the tubular spring support; (e) a second inner spring extending circumferentially from the top washer to a channel support, the channel support extending upwardly from the bottom cup, the channel support forming a pathway for the communication of hydraulic fluid between a main chamber and a second chamber; (f) a first outer spring extending circumferentially from the channel support to an outer spring support; (g) a second outer spring extending circumferentially from the outer spring support to a peripheral edge of the bottom cup; (h) wherein the first inner spring, the second inner spring, and the bottom cup form the main chamber; (i) wherein the first outer spring, the second outer spring, and the bottom cup form the second chamber; and (j) wherein downward displacement of the top washer relative to the bottom cup causes hydraulic fluid to communicate from the main chamber to the second chamber, and upward displacement of the top washer relative to the bottom cup causes hydraulic fluid to communicate from the second chamber to the main chamber, creating a damping effect upon application of a uni-axial or multi-axial load to the hydraulic mount.

In other embodiments, the hydraulic mount may comprise a pin extending downwardly from the top washer, the pin contacting both the first inner spring and the second inner spring.

In additional embodiments, the outer spring support extends upwardly from the bottom cup.

In some embodiments, the second outer spring extends between the outer spring support and a clip that surrounds the outer peripheral edge of the bottom cup.

In yet other embodiments, the hydraulic mount further comprises a spacer associated with a lower end of the tubular spring support.

In other embodiments, the channel support forms a substantially u-shaped member, further wherein the pathway is disposed within the substantially u-shaped channel.

In additional embodiments, the hydraulic mount further comprises a channel ring disposed within the main chamber, wherein the channel ring includes a pathway for the communication of fluid between the main chamber and the second chamber.

According to some embodiments, the hydraulic mount may comprise a plurality of fasteners extending through the bottom cup, the fasteners configured to associate the mount with at least a portion of a chassis of a vehicle.

According to other embodiments, the present technology may be directed to a hydraulic mount that comprises: (a) a first mount assembly that includes: (1) an inner tubular sleeve extending along a central axis; (2) a top cup associated with the inner tubular sleeve; (3) a first inner spring extending circumferentially from a connector to the inner tubular sleeve; (4) a second inner spring extending circumferentially from the connector to a channel support, the channel support extending upwardly from the top cup, the channel support forming a pathway for the communication of hydraulic fluid between a main chamber and a second chamber; (5) a first outer spring extending circumferentially from the channel support to an outer spring support; (6) a second outer spring extending circumferentially from the outer spring support to a peripheral edge of the bottom cup; (7) wherein the first inner spring, the second inner spring, and the top cup form the main chamber; and (8) wherein the first outer spring, the second outer spring, and the top cup form the second chamber; (b) a second mount assembly that includes: (1) an inner tubular sleeve extending along the central axis of the first mount assembly; (2) a bottom cup associated with the inner tubular sleeve; (3) a first inner spring extending circumferentially from a connector to the inner tubular spring; (4) a second inner spring extending circumferentially from the connector to a channel support, the channel support extending upwardly from the bottom cup, the channel support forming a pathway for the communication of hydraulic fluid between a main chamber and a second chamber; (5) a first outer spring extending circumferentially from the channel support to an outer spring support; (6) a second outer spring extending circumferentially from the outer spring support to a peripheral edge of the bottom cup; (7) wherein the first inner spring, the second inner spring, and the bottom cup form the main chamber; and (8) wherein the first outer spring, the second outer spring, and the bottom cup form the second chamber; and (c) wherein the first mount assembly is associated with the second mount assembly such that the connector of the first mount assembly is joined to the connector of the second mount assembly.

In other embodiments, the hydraulic mount further comprises: (d) a plurality of fasteners extending through the top cup of the first mount assembly, the fasteners configured to associate the mount with at least a portion of a chassis of a vehicle; and (e) a plurality of fasteners extending through the bottom cup of the second mount assembly, the fasteners configured to associate the mount with at least a portion of a chassis of a vehicle.

In additional embodiments, the connector of the first mount assembly includes a protrusion that extends therefrom, and the connector of the second mount assembly includes a groove that receives the protrusion of the connector of the first mount assembly.

In some embodiments, the main chambers of both the first and second hydraulic mount assemblies each include a channel ring, the channel ring including a pathway for the communication of fluid between the main chamber and the second chamber.

According to some embodiments, the present technology may be directed to a hydraulic mount that comprises: (a) an inner tubular sleeve having a top washer that extends from a terminal end of the inner tubular sleeve, the inner tubular sleeve extending along a central axis; (b) a tubular spring support surrounding at least a portion of the inner tubular sleeve and forming an annular cavity therebetween; (c) an intermediate support disposed below the top washer; (d) an upper spring assembly that includes: (1) a first inner spring extending circumferentially from a connector associated with the top washer to the tubular spring support; (2) a second inner spring extending circumferentially from the connector to a channel support, the channel support extending upwardly from the intermediate support, the channel support forming a pathway for the communication of hydraulic fluid between a main chamber and a second chamber; (3) a first outer spring extending circumferentially from the channel support to an outer spring support; (4) a second outer spring extending circumferentially from the outer spring support to a peripheral edge of the intermediate support; (5) wherein the first inner spring, the second inner spring, and the intermediate support form the main chamber; and (6) wherein the first outer spring, the second outer spring, and the intermediate support form the second chamber; and (e) a lower spring assembly that includes: (1) a first inner spring extending circumferentially from a connector; (2) a second inner spring extending circumferentially from the connector to a channel support, the channel support extending downwardly from the intermediate support, the channel support forming a pathway for the communication of hydraulic fluid between a main chamber and a second chamber; (3) a first outer spring extending circumferentially from the channel support to an outer spring support; (4) a second outer spring extending circumferentially from the outer spring support to a peripheral edge of the intermediate support; (5) wherein the first inner spring, the second inner spring, and the intermediate support form the main chamber; and (6) wherein the first outer spring, the second outer spring, and the intermediate support form the second chamber.

In other embodiments, the connector associated with the lower spring assembly includes mounting studs that are configured to secure the lower spring assembly to at least a portion of a vehicle.

In additional embodiments, the outer spring support of the upper spring assembly extends upwardly from the intermediate support and the outer spring support of the lower spring assembly extends downwardly from the intermediate support.

In some embodiments, the second outer springs of both the upper and lower spring assemblies extend between the outer spring support and an outer ring that surrounds the outer peripheral edge of the intermediate support.

In additional embodiments, each of the channel supports of the upper and lower spring assemblies each include a substantially u-shaped member.

### DETAILED DESCRIPTION OF THE INVENTION

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters. It will be further understood that several of the figures are merely schematic representations of the mount. As such, some of the components may have been distorted from their actual scale for pictorial clarity.

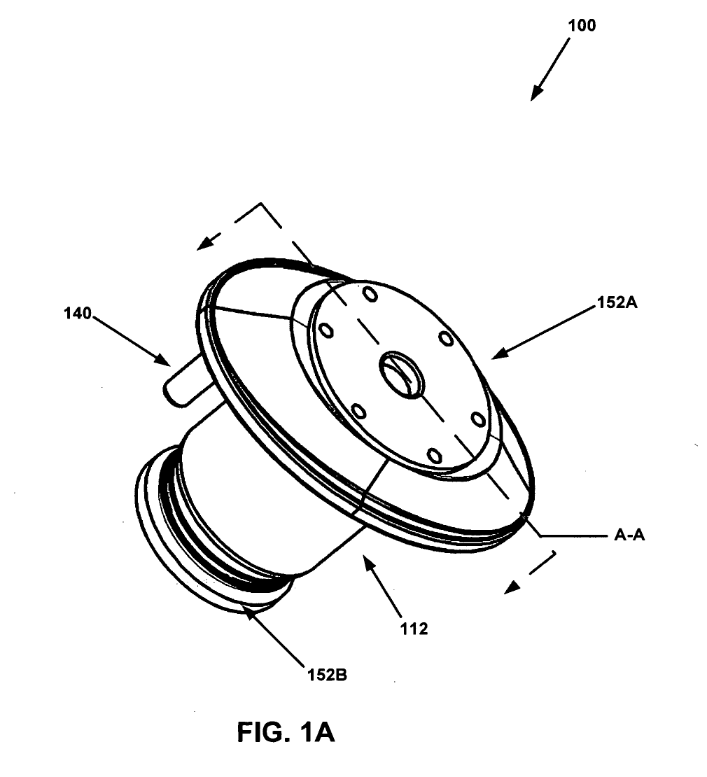

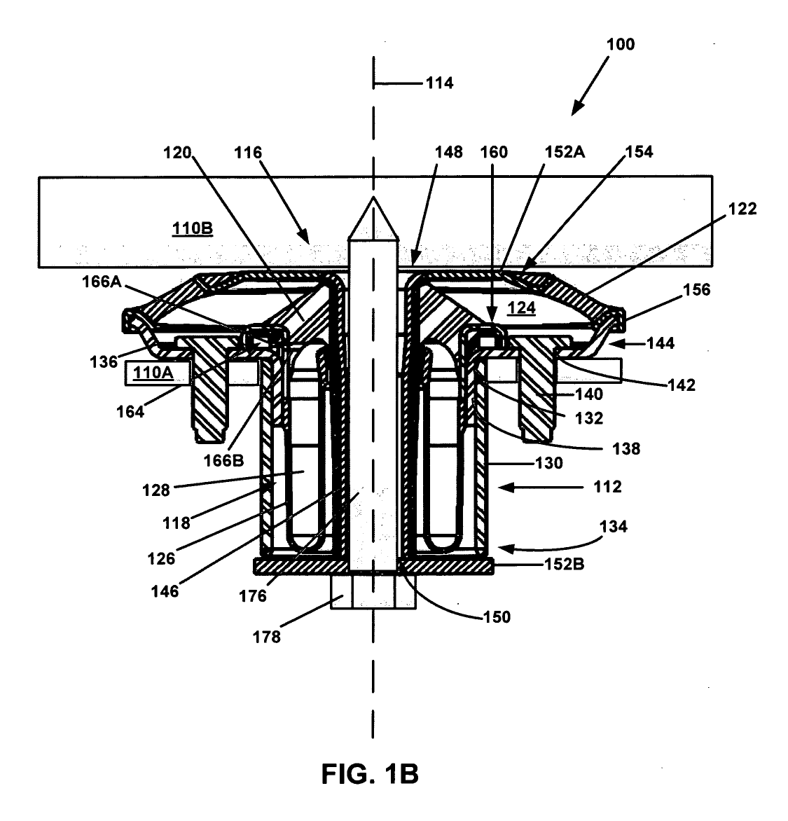

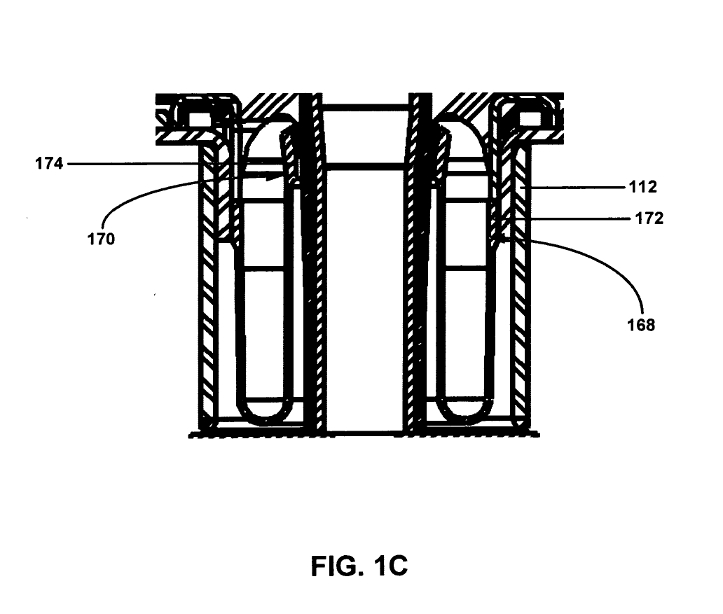

Referring now to the drawings, and more particularly to FIGS. 1A and 1B collectively, hydraulic mount 100, hereinafter sometimes referred to as mount 100, is shown therein. Typically, a plurality of mounts 100 are utilized for damping vibrational forces generated between frame 110A of a vehicle and cab 110B of a vehicle, although one of ordinary skill in the art with the present disclosure before them will appreciate that mount 100 may be utilized for any one of a number of vibrational damping applications.

Typical vibrational damping provided by mount 100 may affect first order vibrations between frame 110A of the vehicle and cab 110B of the vehicle. Moreover, the vibrational damping provided by mount 100 may be achieved due to the resonance of a fluid utilized within mount 100, as will be discussed in greater detail infra. Mount 100 may also be described as a fluid filled damping device that is capable of exhibiting a desired vibration-damping effect on the basis of bidirectional fluid communication through chambers formed in mount 100.

Mount 100 generally comprises outer housing 112 defining central axis 114 extending therethrough, spring support 116 disposed at least partially within outer housing 112 and in substantial axial alignment with central axis 114 so as to form annular cavity 118 therebetween. Mount 100 may also include inner elastomeric spring 120 and outer elastomeric spring 122 being spaced apart from one another to define first chamber 124.

Additionally, mount 100 preferably comprises diaphragm 126 disposed within annular cavity 118 and forming second chamber 128 that is in bilateral fluid communication with first chamber 124. It will be understood that uni-axial or multi-axial displacement of at least one of spring support 116 and outer housing 112 relative to one another causes fluid to communicate between first and second chambers 124 and 128, respectively.

Outer housing 112 may include cylindrical cup portion 130 having first open end 132 and second open end 134. Outer housing 112 may also include medial flange 136 that extends normally to central axis 114. Medial flange 136 may include rim 138 that is adapted to compressively fit within first open end 132 of cylindrical cup portion 130 to secure medial flange 136 to cylindrical cup portion 130. Medial flange 136 may include one or more bolts 140 (e.g., threaded studs) that extend downwardly through flat portion 142 for securing medial flange 136 to the frame of the vehicle (not shown). Additionally, medial flange 136 may include upwardly flared edge 144.

It will be understood that outer housing 112 may be constructed from any one of a number of different types of materials such as a metal, an alloy, a polymer, a resin, a natural product such as rubber, a composite, or any combination thereof. According to some embodiments, outer housing 112 may be fabricated from a material commonly utilized in the automotive industry such as aluminum or aluminum alloys. Outer housing 112 may also include an elastomeric coating that covers at least a portion of the outer surface of outer housing 112.

Spring support 116 preferably comprises body 146 having first and second ends 148 and 150, respectively. Spring support 116 preferably comprises upper flange 152A associated with first end 148 that extends generally normally to central axis 114 of outer housing 112. Upper flange 152A may include arcuate edge 154 that extends around the peripheral end of upper flange 152A and is angled to cooperate with outer elastomeric spring 122, as will be discussed in greater detail infra.

It will be understood that upper flange 152A may optionally include a washer that is adapted to associate with first end 148 of spring support 116. Additionally, spring support 116 may include lower flange 152B associated with second end 150.

It will be understood that spring support 116 may be constructed from any one of a number of different types of materials such as a metal, an alloy, a polymer, a resin, a natural product such as rubber, a composite, or any combination thereof. According to some embodiments, spring support 116 may be fabricated from a material commonly utilized in the automotive industry such as aluminum or aluminum alloys. Spring support 116 may also include an elastomeric coating that covers at least a portion of the outer surface of spring support 116.

Outer elastomeric spring 122 may extend between upwardly flared edge 144 of medial flange 136 of outer housing 112 and arcuate edge 154 of upper flange 152A of spring support 116. According to some embodiments, mount 100 may include outer spring support 156 disposed between upwardly flared edge 144 of outer housing 112 and outer elastomeric spring 122. Outer spring support 156 may be crimped or otherwise secured to upwardly flared edge 144 of outer housing 112.

Inner elastomeric spring 120 may extend between the outer surface of spring support 116 and inner spring support 160 disposed between outer housing 112 and spring support 116. Inner spring support 160 may extend from flat portion 142 of medial flange 136 of outer housing 112 and along the inner surface of rim 138, formed at least partially to surround path 164 that provides bidirectional communication of fluid between first and second chambers 124 and 128, respectively.

It will be understood that path 164 may be co-molded into inner elastomeric spring 120 and include first port 166A disposed along inner elastomeric spring 120 and second port 166B disposed below inner elastomeric spring 120.

First chamber 124 is formed between inner elastomeric spring 120 and outer elastomeric spring 122 and medial flange 136 of outer housing 112 and upper flange 152A of spring support 116.

As is best shown in FIG. 1C, second chamber 128 is formed by diaphragm 126, which in some embodiments includes a substantially U-shaped channel of flexible elastomeric material having first end 168 and second end 170. First end 168 may be attached to outer housing 112 via outer support ring 172. Second end 170 may be attached to the inner surface of spring support 116 via inner support ring 174. Because first and second ends 168 and 170 of diaphragm 126 are connected to outer housing 112 and spring support 116 independently from one another, when spring support 116 and outer housing 112 displace relative to one another, at least one of first end 168 and second end 170 displace causing diaphragm 126 to displace or “roll.”

Moreover, during displacement of either first end 168 or second end 170, mount 100 may act similarly to a shock absorber in that fluid may displace between first chamber 124 and second chamber 128 in a bidirectional manner as to provide suitable vibrational damping between the frame of the vehicle and the cab of the vehicle. For example, if the cab compresses mount 100, spring support 116 transfers compressive forces to inner elastomeric spring 120 and across upper flange 152A, down into outer elastomeric spring 122 and through to medial flange 136 causing first chamber 124 to compress. The compression of first chamber 124 causes fluid in first chamber 124 through path 164 and into second chamber 128. Additionally, first end 168 of diaphragm 126 connected to spring support 116 displaces downwardly relative to second end 170 of diaphragm 126.

It will be understood that the size and shape of first and second chambers 124 and 128 may vary according to design requirements (e.g., desired vibration damping).

In operation, one or more mounts 100 may be secured to frame 110A of the vehicle via one or more bolts 140 that extend at least partially through apertures fabricated into frame 110A. Hexagonal nuts (not shown) may be threaded onto portions of one or more bolts 140 extend through frame 110A. Mount 100 may be secured to cab 110B via bolt 176 that extends through spring support 116 and into cab 110B (e.g., a lower frame plate of the cab). Head 178 of bolt 176 contacts lower flange 152B of spring support 116 urging mount 100 upwardly towards cab 110B.

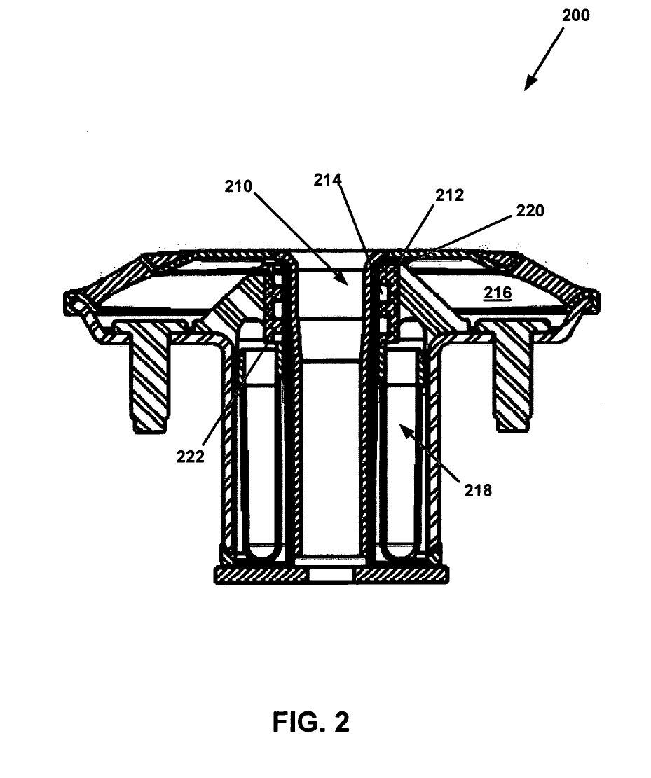

Referring now to FIG. 2, an alternative embodiment of a hydraulic mount, hereinafter referred to as mount 200 is shown. It will be understood that mount 200 may be constructed similarly to mount 100 of FIGS. 1A-1C, with the exception that spring support 210 of mount 200 includes casing 212 that surrounds at least a portion of spring support 210. Casing 212 may include helical path 214 for bilateral communication of fluid between first and second chambers 216 and 218, respectively.

It will be understood that helical path 214 may include first port 220 disposed above body 222 of inner elastomeric spring 224 and second port 226 may be disposed below body 222 of inner elastomeric spring 224.

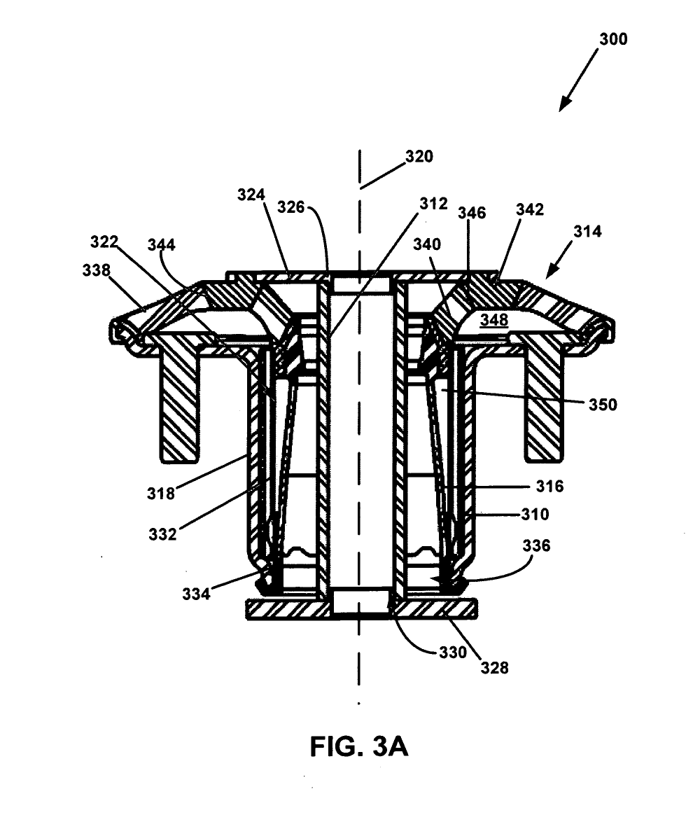

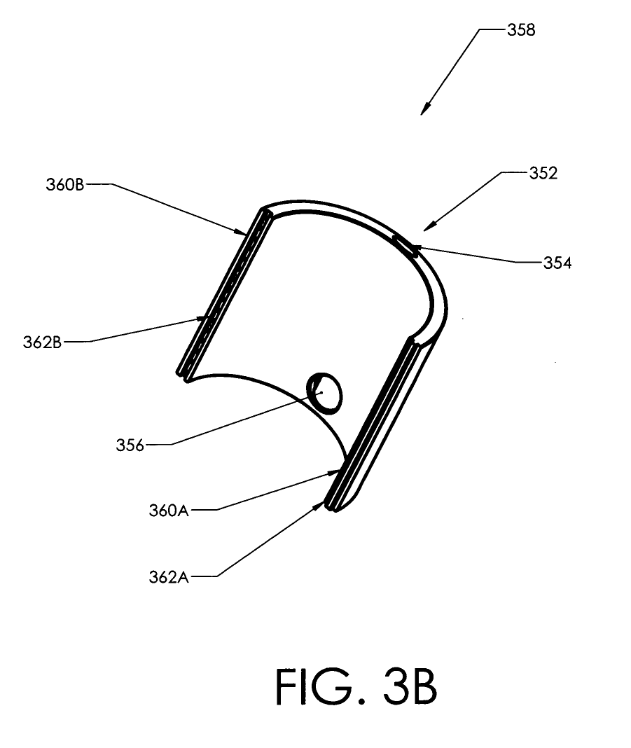

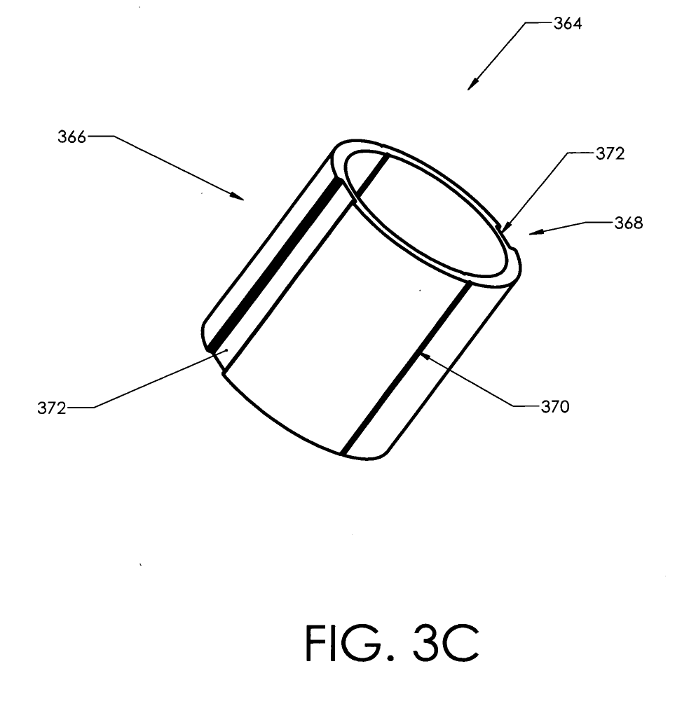

Referring now to FIGS. 3A-3C, an additional alternative embodiment of a hydraulic mount, hereinafter referred to as mount 300 is shown. Mount 300 generally comprises outer housing 310, spring support 312, elastomeric core 314, and diaphragm 316.

Outer housing 310 includes cylindrical tubular portion 318 defining central axis 320 extending therethrough. Spring support 312 may be disposed at least partially within outer housing 310 and in substantial axial alignment with central axis 320 so as to form annular cavity 322 therebetween. Spring support 312 may include first washer 324 associated with first end 326 and second washer 328 associated with second end 330 of spring support 312.

Mount 300 may also include tubular body 332 disposed within annular cavity 322 such that an outer surface of tubular body 332 contacts an inner surface of outer housing 310. Tubular body 332 may rest upon support member 334 that is also utilized to associate a terminal end of diaphragm 316 with first end 336 of outer housing 310.

Elastomeric core 314 extends between first washer 324 of spring support 312 and outer housing 310. Additionally, elastomeric core 314 may be divided into outer portion 338 and inner portion 340 by connector 342 that extends downwardly from first washer 324. Connector 342 includes first angled surface 344 that contacts outer portion 338 and second angled surface 346 that contacts inner portion 340.

Elastomeric core 314 cooperates with outer housing 310 to form first chamber 348. Diaphragm 316 may extend downwardly and flare outwardly from central axis 320 to contact first end 336 of outer housing 310, forming second chamber 350. Additionally, diaphragm 316 may be secured to first end 336 of outer housing 310 via support member 334.

Referring now to FIGS. 3A and 3B collectively, tubular body 332 extends between first chamber 348 and second chamber 350 and includes two paths 352 for bidirectional communication of fluid therebetween. Paths 352 may each include first port 354 associated with first chamber 348 and second port 356 associated with second chamber 350. FIG. 3B shows only first portion 358 of tubular body 332 that may be joined together with a second portion (not shown) via joints 360A and 360B, which in this embodiment includes male (362A) and female (362B) dovetail sections.

It will be understood that one particular advantage mount 300 includes the ability to mold both elastomeric core 314 and diaphragm 316 in a singular molding process, thereby reducing manufacturing costs associated with fabricating mount 300.

Referring now to FIG. 3C, an alternative tubular body 364 is shown. Tubular body 364 may be fabricated from a single piece of polymeric material. The singular piece may then split into two sections 366 and 368 along fine notch lines 370 that extend along the length of tubular body 364 by lowering the temperature of tubular body 364 below the “glass transition temperature.” Below this temperature, the material is very brittle and allows tubular body 364 to be split along fine notch lines 370 into sections 366 and 368 that mate to each other. It will be understood that the fractured surfaces of sections 366 and 368 match each other so that there is negligible internal leakage from inside diameter to outside diameter.

Tubular body 364 may include fluid channels 372 that cooperate with the inner surface of outer housing 310 to form paths for bidirectional communication of fluid between first and second chambers 348 and 350, respectively.

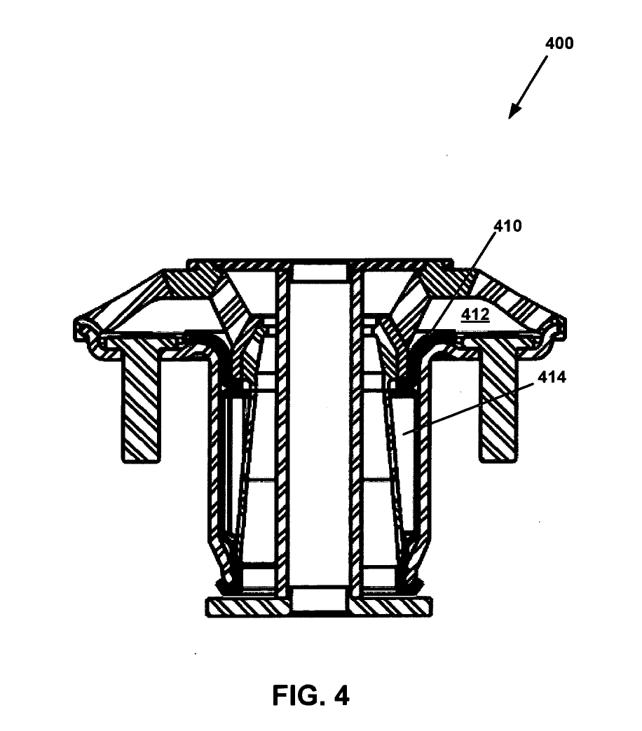

FIG. 4 illustrates yet another embodiment of a hydraulic mount, hereinafter referred to as mount 400. Mount 400 is constructed similarly to mount 300 (see FIG. 3A) with the exception that rather than having a tubular body, mount 400 is provided with tubular spacer 410. A notch in tubular spacer 410 provides bilateral communication of fluid between first chamber 412 and second chamber 414.

In accordance with the present invention, the mount may comprise the upper mount in a two mount arrangement sandwiching the frame as has been done for many years, or it can be bolted to the frame as a single mount. There are two chambers and a connecting channel. The damping of this device is achieved by the resonance of the mass of fluid in the channel.

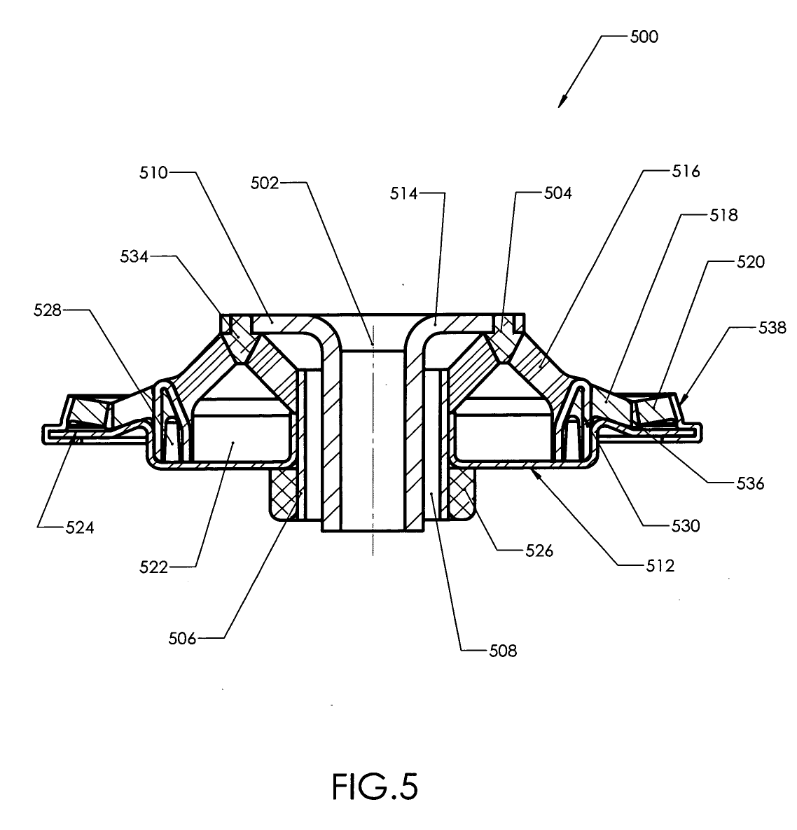

Referring now to FIG. 5, mount 500 is shown as comprising four concentric elastomeric springs, which can be molded at the same time in one mold. Mount 500 generally comprises an inner tubular sleeve 502 defining central axis 504 extending therethrough. Inner tubular sleeve 502 may be inserted into spring support 506 in substantial axial alignment with central axis 504 so as to form annular cavity 508 therebetween.

It is noteworthy to mention that all mounts disclosed herein may be adapted to join with at least a portion of a frame (or other portion) of a vehicle via bolts, pins, clips, adhesives, threads, and so forth, as shown in FIG. 5.

According to some embodiments, the inner tubular sleeve 502 may include top washer 510 that extends normally to the upper terminal end of inner tubular sleeve 502. In some embodiments, top washer 510 may threadably couple with the terminal end of inner tubular sleeve 502. Additionally, mount 500 may include bottom cup 512 that is spaced apart from top washer 510 such that at least a portion of the four springs may extend therebetween.

According to some embodiments, the inner two springs such as first inner spring 514 and second inner spring 516 comprise the load bearing springs and also pump fluid (not shown). Additionally, two outer springs, such as first outer spring 518 and second outer spring 520 will not directly support a load applied to mount 500.

First and second inner springs 514 and 516 are spaced apart from one another to form main chamber 522 that receives and retains a hydraulic fluid. It will be understood that the hydraulic fluid may comprise any suitable hydraulic fluid that would be known to one of ordinary skill in the art with the present disclosure before them.

Additionally, first and second outer springs 518 and 520 may cooperate to form second chamber 524. In accordance with the present technology, upon application of a load to mount 500, hydraulic fluid passes from main chamber 522 to secondary chamber 524, for example, as the upper surface of mount 500 moves downwardly. As the upper surface moves upward, the flow is reversed.

According to some embodiments, mount 500 may include an interchangeable spacer 526 that surrounds the lower end of spring support 506 that allows mount 500 to be joined to a variety of different sizes of vehicles.

The basic damping capability of mount 500 may be dependent on the effective piston area of two inner springs 514 and 516. But in addition, the effect of two outer springs 518 and 520 is considered. Outer springs 518 and 520 are in fact load-bearing springs turned upside down. When the second chamber 524 is filled by fluid from the main chamber 522, two outer springs 518 and 520 resist main chamber 522 from filling and also pressurize the fluid. When the load is subsequently removed from mount 500, the pressurized fluid then drives back into main chamber 522 from secondary chamber 524. This type of hydrostatic balancing may occur relatively quickly (e.g., quickly respond to application and removal of loads to the mount) and is thus a part of the dynamic characteristic of mount 500. This would not happen if two outer springs 518 and 520 were merely a diaphragm.

In some embodiments, main chamber 522 may be in fluid communication with second chamber 524 via pathway 528 that extends through channel support 530. Advantageously, channel support 530 may extend from the top surface of bottom cup 512 and form a cavity that includes pathway 528. Fluid may be exchanged between main chamber 522 and second chamber 524 via pathway 528.

Although not limiting in its description, mount 500 may be considered an approximation to a “Double Acting Pumper” mount where the fluid is driven in both directions by the motion of the upper surface of the mount.

According to some embodiments, the construction of mount 500 comprises a monolithic molded part (inner and outer springs) and bottom cup 512 to form one or more of the fluid containing structures (e.g., chambers). There is preferably a crimp and seal on the outside connection between the molded part and bottom cup and a seal on the inside connection where the two parts push together.

Top washer 510 and inner tubular sleeve 502 are located to the molded part with holes that match pins on the molded elastomeric springs. Top washer 510 and inner tubular sleeve 502 are then attached to the first and second inner springs 514 and 516 by the action of forming pins that extend from the lower surface of top washer 510. It will be understood that top washer 510 and inner tubular sleeve 502 may be combined into one component.

In some embodiments, first inner spring 514 may extend circumferentially from connector 534 of top washer 510 to inner spring support 506. Additionally, second inner spring 516 may extend circumferentially from connector 534 of top washer 510 to channel support 530, which extends upwardly from bottom cup 512. According to the present technology, channel support 530 may form a pathway for the communication of hydraulic fluid between main chamber 522 and second chamber 524. Additionally, first outer spring 518 may extend circumferentially from channel support 530 to outer spring support 536. Second outer spring 520 may extend circumferentially from outer spring support 536 to a peripheral edge of bottom cup 512. Clip 538 may be crimped around the peripheral edge of bottom cup 512 and extend upwardly from bottom cup 512 to engage second outer spring 520. It will be understood that, in certain embodiments, clip 538 is mold bonded to second outer spring 520.

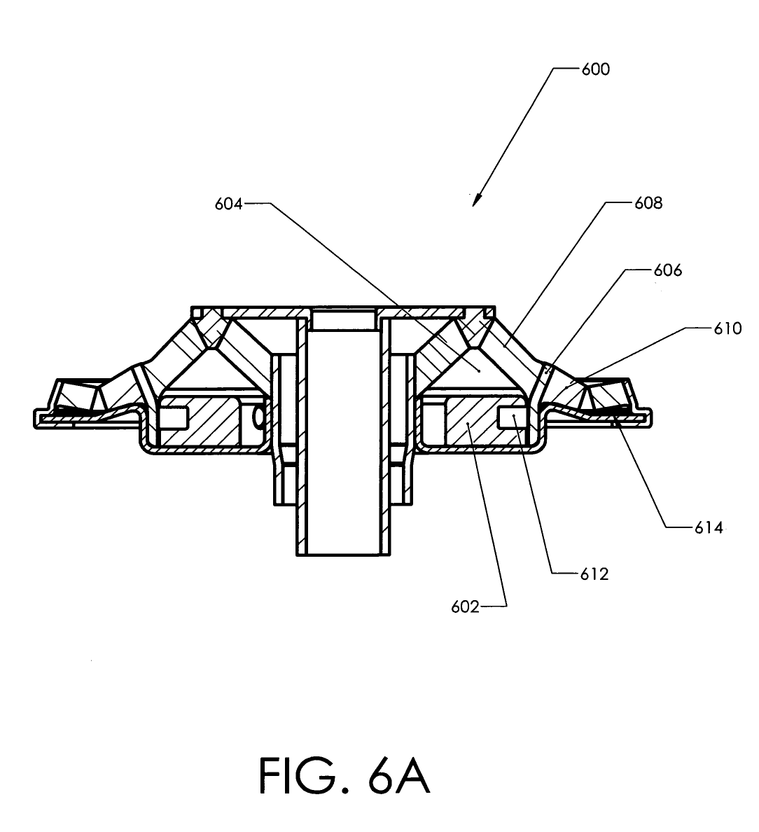

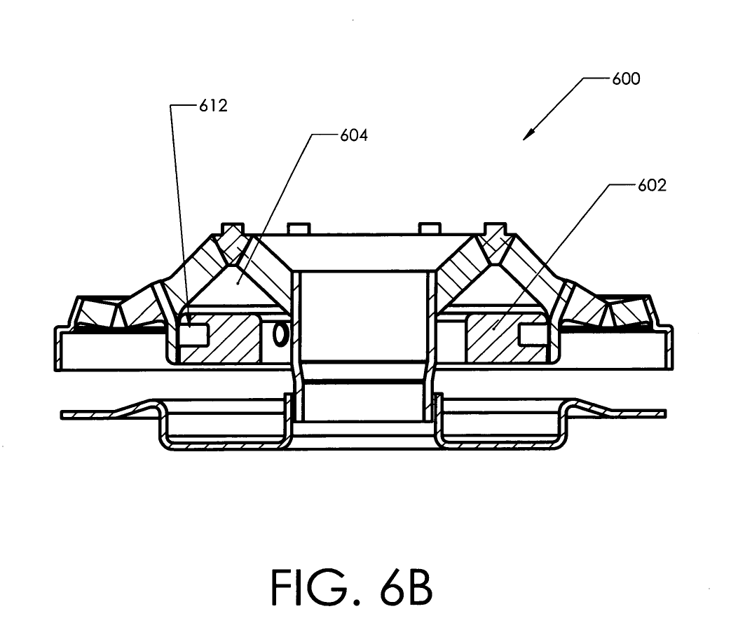

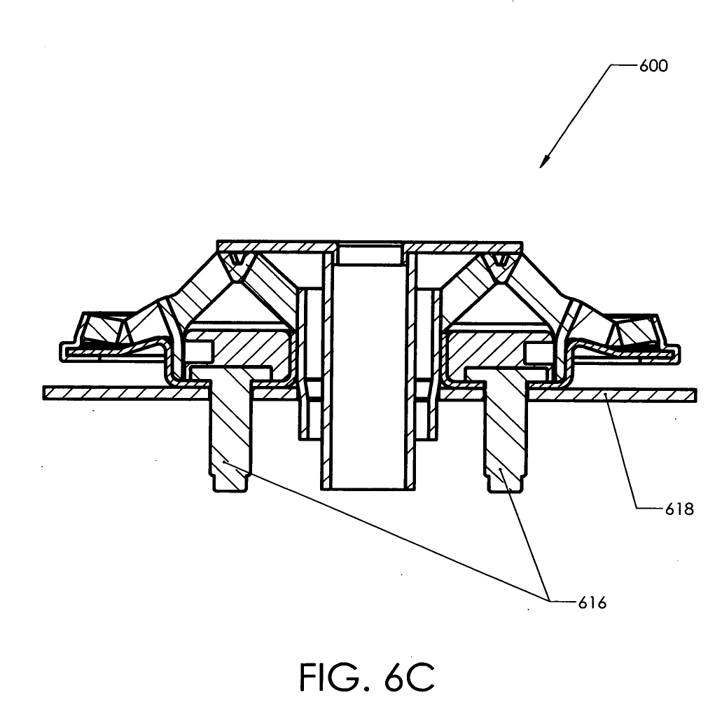

Turning now to FIGS. 6A-6C collectively, an alternative mount 600 is shown therein. Mount 600 is constructed similarly to mount 500 of FIG. 5, with the exception that mount 600 includes channel ring 602 that is inserted into main chamber 604 and contacts channel and spring support 606. Channel and spring support 606 is shown as disposed between second inner spring 608 and first outer spring 610. In some embodiments channel ring 602 contacts the inside diameter of channel and spring support 606. The utilization of channel ring 602 may reduce the outside diameter of mount 600. Channel and spring support 606 may include pathway 612 for the communication of fluids between main chamber 604 and second chamber 614.

FIG. 6B illustrates two halves of mount 600 that contain hydraulic fluid, in spaced apart relationship to one another. Although not shown, channel ring 602 may be replaced by a “barbed connector and tube” pushed into channel and spring support 606. In this configuration the tube may form connecting pathway 612 and reside inside main chamber 604.

FIG. 6C illustrates mount 600 with bolts 616, in an installed configuration relative to vehicle chassis 618.

Now, elastomeric/hydraulic damping mounts in general have a characteristic where the damping available is proportional to the amplitude of the imposed displacement. In fact, it may be substantially inversely proportional such that the smaller the displacement is, the larger the damping. Because this mount configuration (the elastomeric spring assisted damping all in one mold) is very low cost, it is feasible to envisage stacking two mounts on top of each other to further increase enhance damping.

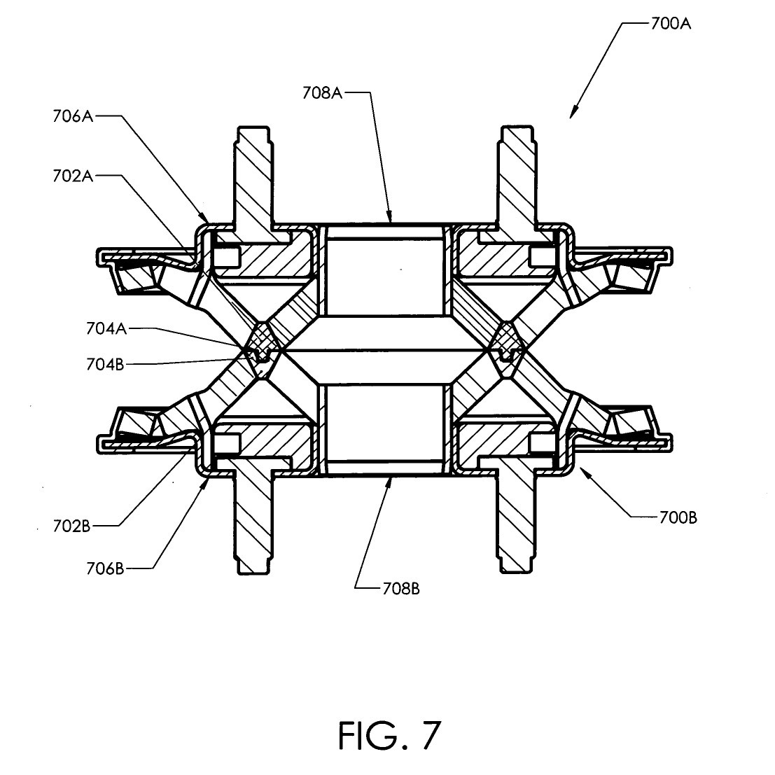

FIG. 7 illustrates an exemplary double hydraulic mount, comprised of two individual mounts 700A and 700B. Mounts 700A and 700B may be installed such that top pins 702A and 702B are disposed in face-to-face relationship relative to one another. In some embodiments, protrusion 704A on top mount 700A may be inserted into sockets 704B on bottom mount 700B so that the two mounts lock together. According to some embodiments, top mount 700A may include a top cup 706A associated with tubular sleeve 708A. Likewise, bottom mount 700B may include top cup 706B associated with tubular sleeve 708B.

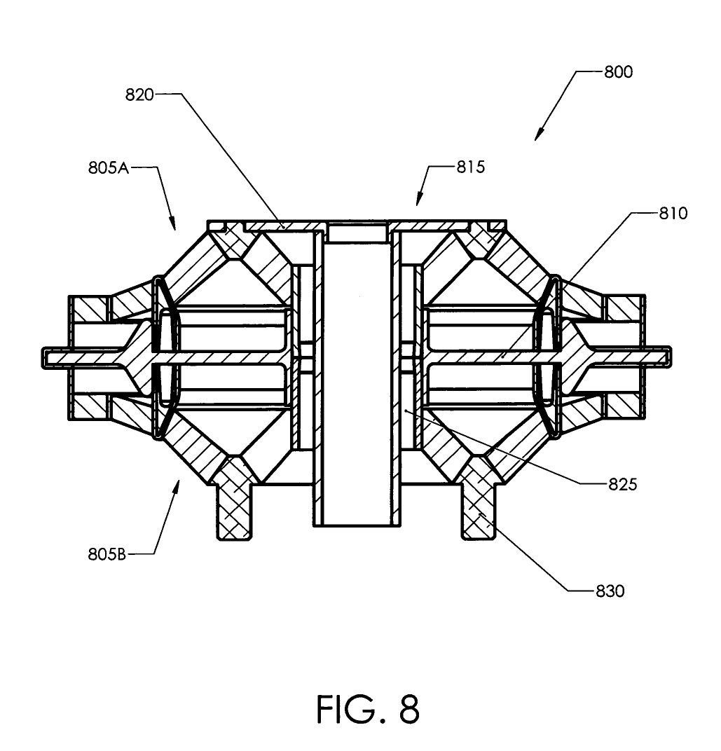

Alternatively, the two mounts 700A and 700B could be combined such that the bottom cup of one mount joins with the bottom cup of the second mount forming a single unitary member extending through the middle of the mount, as is best shown in FIG. 8. The two bottom cups are combined into one component.

Moreover, FIG. 8 illustrates exemplary double hydraulic mount 800 having upper spring assembly 805A and lower spring assembly 805B spaced apart from one another by intermediate support 810. In some embodiments, mount 800 may include tubular sleeve 810 having top washer 815 extending therefrom. It is noteworthy to mention that tubular sleeve extends through mount 800. Mount 800 may also include tubular spring support 820 that may comprise two individual tubular spring supports in mating relationship to one another. Additionally, mount 800 may include studs 825 that extend downwardly from lower spring assembly 805B that may be utilized to join mount 800 to at least a portion of a vehicle (not shown).

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A hydraulic mount, comprising:
an inner tubular sleeve having a top washer extending circumferentially from a terminal end of the inner tubular sleeve, the inner tubular sleeve extending along a central axis;
a tubular spring support surrounding at least a portion of the inner tubular sleeve and forming an annular cavity therebetween;
a bottom cup disposed below the top washer;
a first inner spring extending circumferentially from the top washer to the tubular spring support;
a second inner spring extending circumferentially from the top washer to a channel support, the channel support extending upwardly from the bottom cup, the channel support forming a pathway for the communication of hydraulic fluid between a main chamber and a second chamber;
a first outer spring extending circumferentially from the channel support to an outer spring support;
a second outer spring extending circumferentially from the outer spring support to a peripheral edge of the bottom cup;
wherein the first inner spring, the second inner spring, and the bottom cup form the main chamber;
wherein the first outer spring, the second outer spring, and the bottom cup form the second chamber; and
wherein downward displacement of the top washer relative to the bottom cup causes hydraulic fluid to communicate from the main chamber to the second chamber, and upward displacement of the top washer relative to the bottom cup causes hydraulic fluid to communicate from the second chamber to the main chamber, creating a damping effect upon application of a uni-axial or multi-axial load to the hydraulic mount.

2. The hydraulic mount according to claim 1, further comprising a pin extending downwardly from the top washer, the pin contacting both the first inner spring and the second inner spring.

3. The hydraulic mount according to claim 1, wherein the outer spring support extends upwardly from the bottom cup.

4. The hydraulic mount according to claim 3, wherein second outer spring extends between the outer spring support and a clip that surrounds the outer peripheral edge of the bottom cup.

5. The hydraulic mount according to claim 1, further comprising a spacer associated with a lower end of the tubular spring support.

6. The hydraulic mount according to claim 1, wherein the channel support forms a substantially u-shaped member, further wherein the pathway is disposed within the substantially u-shaped channel.

7. The hydraulic mount according to claim 1, further comprising a channel ring disposed within the main chamber, wherein the channel ring includes a pathway for the communication of fluid between the main chamber and the second chamber.

8. The hydraulic mount according to claim 1, further comprising a plurality of fasteners extending through the bottom cup, the fasteners configured to associate the mount with at least a portion of a chassis of a vehicle.

9. A hydraulic mount, comprising:
a first mount assembly that includes:
an inner tubular sleeve extending along a central axis;
a top cup associated with the inner tubular sleeve;
a first inner spring extending circumferentially from a connector to the inner tubular sleeve;
a second inner spring extending circumferentially from the connector to a channel support, the channel support extending upwardly from the top cup, the channel support forming a pathway for the communication of hydraulic fluid between a main chamber and a second chamber;
a first outer spring extending circumferentially from the channel support to an outer spring support;
a second outer spring extending circumferentially from the outer spring support to a peripheral edge of the bottom cup;
wherein the first inner spring, the second inner spring, and the top cup form the main chamber; and
wherein the first outer spring, the second outer spring, and the top cup form the second chamber;
a second mount assembly that includes:
an inner tubular sleeve the extending along the central axis of the first mount assembly;
a bottom cup associated with the inner tubular sleeve;
a first inner spring extending circumferentially from a connector to the inner tubular spring;
a second inner spring extending circumferentially from the connector to a channel support, the channel support extending upwardly from the bottom cup, the channel support forming a pathway for the communication of hydraulic fluid between a main chamber and a second chamber;
a first outer spring extending circumferentially from the channel support to an outer spring support;
a second outer spring extending circumferentially from the outer spring support to a peripheral edge of the bottom cup;
wherein the first inner spring, the second inner spring, and the bottom cup form the main chamber; and
wherein the first outer spring, the second outer spring, and the bottom cup form the second chamber; and
wherein the first mount assembly is associated with the second mount assembly such that the connector of the first mount assembly is joined to the connector of the second mount assembly.

10. The hydraulic mount according to claim 9, further comprising:
a plurality of fasteners extending through the top cup of the first mount assembly, the fasteners configured to associate the mount with at least a portion of a chassis of a vehicle; and
a plurality of fasteners extending through the bottom cup of the second mount assembly, the fasteners configured to associate the mount with at least a portion of a chassis of a vehicle.

11. The hydraulic mount according to claim 9, wherein the connector of the first mount assembly includes a protrusion that extends therefrom, and the connector of the second mount assembly includes a groove that receives the protrusion of the connector of the first mount assembly.

12. The hydraulic mount according to claim 9, wherein the main chambers of both the first and second hydraulic mount assemblies each include a channel ring, the channel ring including a pathway for the communication of fluid between the main chamber and the second chamber.

13. A hydraulic mount, comprising:
an inner tubular sleeve having a top washer that extends from a terminal end of the inner tubular sleeve, the inner tubular sleeve extending along a central axis;
a tubular spring support surrounding at least a portion of the inner tubular sleeve and forming an annular cavity therebetween;
an intermediate support disposed below the top washer;
an upper spring assembly that includes:
a first inner spring extending circumferentially from a connector associated with the top washer to the tubular spring support;
a second inner spring extending circumferentially from the connector to a channel support, the channel support extending upwardly from the intermediate support, the channel support forming a pathway for the communication of hydraulic fluid between a main chamber and a second chamber;
a first outer spring extending circumferentially from the channel support to an outer spring support;
a second outer spring extending circumferentially from the outer spring support to a peripheral edge of the intermediate support;
wherein the first inner spring, the second inner spring, and the intermediate support form the main chamber; and
wherein the first outer spring, the second outer spring, and the intermediate support form the second chamber; and
a lower spring assembly that includes:
a first inner spring extending circumferentially from a connector;
a second inner spring extending circumferentially from the connector to a channel support, the channel support extending downwardly from the intermediate support, the channel support forming a pathway for the communication of hydraulic fluid between a main chamber and a second chamber;
a first outer spring extending circumferentially from the channel support to an outer spring support;
a second outer spring extending circumferentially from the outer spring support to a peripheral edge of the intermediate support;
wherein the first inner spring, the second inner spring, and the intermediate support form the main chamber; and
wherein the first outer spring, the second outer spring, and the intermediate support form the second chamber.

14. The hydraulic mount according to claim 13, wherein the connector associated with the lower spring assembly includes mounting studs that are configured to secure the lower spring assembly to at least a portion of a vehicle.

15. The hydraulic mount according to claim 13, wherein the outer spring support of the upper spring assembly extends upwardly from the intermediate support and the outer spring support of the lower spring assembly extends downwardly from the intermediate support.

16. The hydraulic mount according to claim 13, wherein the second outer springs of both the upper and lower spring assemblies extend between the outer spring support and an outer ring that surrounds the outer peripheral edge of the intermediate support.

17. The hydraulic mount according to claim 13, wherein each of the channel supports of the upper and lower spring assemblies each include a substantially u-shaped member.
